(19) United States
(12) Patent Application Publication
(10) Pub. No.: US 2026/0211828 A1
(43) Pub. Date: Jul. 23, 2026

(54) SYSTEM AND METHOD FOR HARDWARE-BASED DATA TRANSFER

(71) Applicant: Chipspirit Technologies Pvt Ltd, Bangalore (IN)

(72) Inventors: Mohan Kumar Jindal, Bangalore (IN); Srirama Chandra Murthy Pratapa, Bangalore (IN); V M Sanchith, Bangalore (IN); Ashish Shridhar Jadhao, Bangalore (IN); Sumit Manoj Kavathekar, Bangalore (IN); Mayur Gulab Khairnar, Bangalore (IN); Ravindra Madan Lande, Bangalore (IN); Battula Sesha Sowjanya, Bangalore (IN); Tejasvi Reddy, Bangalore (IN); Akanksha Kishor Bedekar, Bangalore (IN); Jaspritam Singh, Bangalore (IN); Pratiksha Ishwar Jondhale, Bangalore (IN)

(73) Assignee: Chipspirit Technologies Pvt Ltd, Bangalore (IN)

(21) Appl. No.: 19/571,093

(22) Filed: Mar. 18, 2026

Related U.S. Application Data
(63) Continuation-in-part of application No. PCT/IN2024/051450, filed on Aug. 3, 2024.

(30) Foreign Application Priority Data
Sep. 18, 2023 (IN) 202341062699

(51) Int. Cl. G06F 13/38; G06F 13/42

(52) U.S. Cl. CPC G06F 13/382; G06F 13/4282; G06F 2213/0042

(57) ABSTRACT

A system includes a plurality of USB subunits, one or more support units to generate a set of status signals based on a status of operation of the one or more support units, a master controller to generate a plurality of mode signals for the plurality of USB subunits based on a status of dependence of the plurality of USB subunits, and a sequence controller to generate a set of initialization signals for the plurality of USB subunits based on the one or more status signals and the plurality of mode signals, initialize the plurality of USB subunits with a predefined set of initialization protocols based on the set of initialization signals, and control a transfer of data between the plurality of USB subunits. Various components of the system are implemented on FPGA, ASIC, or a combination thereof.

### CROSS-REFERENCE TO RELATED APPLICATIONS

This application is a continuation-in-part of PCT Application No. PCT/IN2024/051450, filed on Aug. 3, 2024, which claims priority to Indian Application No. 202341062699, filed Sep. 18, 2023, the complete disclosures of which, in their entireties, are herein incorporated by reference.

### TECHNICAL FIELD

The present disclosure relates generally to data communication. More particularly, the present disclosure relates to a system and a method for hardware-based data transfer.

### BACKGROUND

Initialization of data transfer and providing supportive protocols to is a preliminary step to enable data transfer between data storage devices. Typically, the contemporary systems provide initialization of data transfer and support to the data storage devices through software-defined protocols (i.e., by way of initialization drivers). The initialization drivers control and modify the specifications of the data transfer path to determine specifications (or requirements) of data storage devices, and enable successful transfer of data amongst multiple data storage devices.

However, the software-defined protocols for initialization of data transfer between data storage devices is easily hackable, and thus and the associated functionality of such systems is prone to cyber-attacks. Therefore, there is a possibility of compromising the information contents of the data while transferring data using systems employing software-defined protocols for initialization of data transfer.

Thus, there is a need for a system and a method capable of providing secure data transfer between data storage devices, which demands a need for improvised technical solution that overcomes the aforementioned problems.

### SUMMARY

In an aspect of the present disclosure, a system includes a plurality of Universal Serial Bus (USB) subunits, one or more support units, a master controller and a sequence controller that is coupled to the master controller and the one or more support units. The master controller, the one or more support units, and the sequence controller are implemented on at least one of a Field Programmable Gate Array (FPGA), an Application-Specific Integrated Circuit (ASIC), or a combination thereof. The one or more support units is configured to generate a set of status signals based on a status of operation of each support unit of the one or more support units. The master controller is configured to generate a plurality of mode signals for the plurality of USB subunits based on a status of dependence of each USB subunit of the plurality of USB subunits on the one or more support units. The sequence controller is configured to generate a set of initialization signals for the plurality of USB subunits based on the one or more status signals and a comparison of the plurality of mode signals with a set of predefined signals. The sequence controller is further configured to initialize the plurality of USB subunits with a predefined set of initialization protocols based on the set of initialization signals. Furthermore, the sequence controller is configured to control a transfer of data between the plurality of USB subunits.

In some aspects, prior to the generation of the plurality of mode signals, the master controller is configured to determine a plurality of specifications of the plurality of USB subunits, compare the plurality of specifications with a set of predefined specifications, and determine the status of the dependence of each USB subunit of the plurality of USB subunits on the one or more support units based on the comparison.

In some aspects, prior to the generation of the one or more status signals, each support unit of the one or more support units are configured to determine a set of parametric values for a set of predefined performance parameters associated with each support unit, compare the set of parametric values for each support unit with a predefined set of value, and determine the status of operation of each support unit based on the comparison.

In some aspects, the predefined set of initialization protocols comprising at least one of a parallel initiation of the plurality of USB subunits, a sequential initiation of the plurality of USB subunits, or a combination thereof.

In some aspects, upon initialization of the plurality of USB subunits, the sequence controller is configured to determine a duration of initialization for each USB subunit of the plurality of USB subunits, The sequence controller is further configured to compare the duration of initialization of each USB subunit with an predefined threshold value. Furthermore, the sequence controller is configured to generate an error signal for one or more USB subunits of the plurality of USB subunits when the duration of initialization of the one or more USB subunits is greater than the predefined threshold value. Furthermore, the sequence controller is configured to generate a data transfer signal to enable the transfer of data between the plurality of USB subunits, when the duration of initialization of two or more USB subunits of the plurality of subunits is less than or equal to the predefined threshold value.

In some other aspects of the present disclosure, a method includes generating, by way of one or more support units, a set of status signals based on a status of operation of each support unit of the one or more support units. The method further includes generating, by way of a master controller, a plurality of mode signals for a plurality of USB subunits based on a status of dependence of each USB subunit of the plurality of USB subunits on the one or more support units. Furthermore, the method includes generating, by way of a sequence controller, a set of initialization signals for the plurality of USB subunits based on the one or more status signals and a comparison of the plurality of mode signals with a set of predefined signals. Furthermore, the method includes initializing, by way of the sequence controller, the plurality of USB subunits with a predefined set of initialization protocols based on the set of initialization signals. Furthermore, the method includes controlling, by way of the sequence controller, a transfer of data between the plurality of USB subunits. The master controller, the one or more support units, and the sequence controller are implemented on at least one of a Field Programmable Gate Array (FPGA), an Application-Specific Integrated Circuit (ASIC), or a combination thereof.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates a block diagram of a system for hardware-based data transfer, in accordance with an exemplary aspect of the present disclosure; and

FIG. 2 illustrates a flow chart of a method for the hardware-based data transfer, in accordance with an exemplary aspect of the present disclosure.

To facilitate understanding, like reference numerals have been used, where possible, to designate like elements common to the figures.

### DETAILED DESCRIPTION

Various aspect of the present disclosure provides a system and a method for hardware-based data transfer between data storage devices. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element is referred to as being “on,” “connected to,” or “coupled to” another element, it can be directly on, connected to, or coupled to the other element or intervening elements that may be present. As used herein, the term “and/or” includes any and all combinations of one or more of the associated listed items.

The subject matter of example aspects, as disclosed herein, is described with specificity to meet statutory requirements. However, the description itself is not intended to limit the scope of this patent. Rather, the inventor/inventors have contemplated that the claimed subject matter might also be embodied in other ways, to include different features or combinations of features similar to the ones described in this document, in conjunction with other technologies. Generally, the various aspects including the example aspects relate to the system and the method for hardware-based data transfer between data storage devices.

As mentioned, there is a need for a system and a method capable of providing secure data transfer between data storage devices. The present aspects, therefore: provides the system and the method that provides secure data transfer in a sequential manner or a parallel manner between storage devices to overcome the aforementioned problems.

The aspects herein and the various features and advantageous details thereof are explained more fully with reference to the non-limiting aspects that are illustrated in the accompanying drawings and detailed in the following description. Descriptions of well-known components and processing techniques are omitted so as to not unnecessarily obscure the aspects herein. The examples used herein are intended merely to facilitate an understanding of ways in which the aspects herein may be practiced and to further enable those of skill in the art to practice the aspects herein. Accordingly, the examples should not be construed as limiting the scope of the aspects herein.

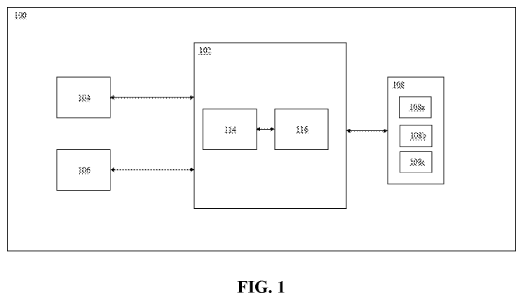

FIG. 1 illustrates a block diagram of the system 100 for hardware-based data transfer, in accordance with an exemplary aspect of the present disclosure. The system 100 may include a sequence controller 102 coupled with a master controller 104, one or more support units 106, and a plurality of Universal Serial Bus (USB) subunits 108.

The system 100 can be implemented using a hardware-based digital design circuitry (such as Field Programmable Gate Arrays (FPGAs), Application Specific Integrated Circuits (ASICs), a combination of FPGAs and ASICs, and the like, and does not include any software-derived microcontroller for operation. Specifically, the sequence controller 102, the master controller 104, the one or more support units 106, and the plurality of Universal Serial Bus (USB) subunits 108 may be implemented using a digital design hardware (such as a Field Programmable Gate Array (FPGA), an Application Specific Integrated Circuits (ASICs), and the like).

The one or more support units 106 may be configured to generate a set of status signals based on a status of operation of each support unit of the one or more support units 106. In some aspects of the present disclosure, to generate the set of status signals. Furthermore, each support unit of the one or more support units 106 may be configured to determine the status of operation of each support unit based on the comparison of the set of parametric values for each support unit with the predefined set of value. In some aspects of the present disclosure, the set of support signals generated by the one or more support units 106 may include a support signal associated with each support unit of the one or more support units 106 such that each support signal may represent a readiness of the associated support unit of the one or more support units 106 to provide support to the sequence controller 102 for initialization of the plurality of USB subunits 108 as and when required by the sequence controller 102.

The master controller 104 may be configured to generate a plurality of mode signals for the plurality of USB subunits 108 based on a status of dependence of each USB subunit of the plurality of USB subunits 108 on the one or more support units 106. In some aspects of the present disclosure, to generate the plurality of mode signals, the master controller 104 may be configured to determine a plurality of specifications of the plurality of USB subunits 108 (i.e., specifications of each USB subunit of the plurality of USB subunits 108 are cumulatively referred to as the plurality of specifications). The master controller 104 may further be configured to compare the plurality of specifications with a set of predefined specifications. Furthermore, the master controller 104 may be configured to determine the status of the dependence of each USB subunit of the plurality of USB subunits on the one or more support units 106 based on the comparison of the plurality of specifications with the set of predefined specifications. In some aspects of the present disclosure, the master controller 104 may be configured to generate a mode signal for a USB subunit of the plurality of USB subunits based on the status of dependence of the USB subunit of the plurality of USB subunits 108 (i.e., the mode signal of each USB subunit of the plurality of USB subunits 108 are cumulatively referred to as the plurality of mode signals for the plurality of USB subunits 108).

The sequence controller 102 may be configured to receive the one or more status signals and the plurality of mode signals from the one or more support subunits 106 and the master controller 104, respectively. In some aspects of the present disclosure, the sequence controller 102 may include an initialization engine 114 and a hardware-timer 116 coupled to each other. The initialization engine 114 and the hardware-timer 116 may be implemented using a digital design hardware (such as Field Programmable Gate Arrays (FPGAs), Application Specific Integrated Circuits (ASICs), a combination of FPGAs and ASICs, and the like, and does not include any software-derived microcontroller for operation. The initialization engine 114 may be configured to compare the plurality of mode signals with a set of predefined signals. The initialization engine 114 may further be configured to generate a set of initialization signals for the plurality of USB subunits 108 based on the one or more status signals and the comparison of the plurality of mode signals with the set of predefined signals. Based on the set of initialization signals, the initialization engine 114 may be configured to initialize the plurality of USB subunits 108 with a predefined set of initialization protocols. In some aspects of the present disclosure, the predefined set of initialization protocols enable the initialization engine 114 for at least one of a parallel initiation of the plurality of USB subunits 108, a sequential initiation of the plurality of USB subunits 108, or a combination thereof. The initialization engine 114 may further be configured to control a transfer of data between the plurality of USB subunits 108.

Upon initialization of the plurality of USB subunits 108, by the initialization engine 114, the hardware-timer 116 may be configured to determine a duration of initialization for each USB subunit of the plurality of USB subunits 108. In some aspects of the present disclosure, the duration of initialization for each USB subunit of the plurality of USB subunits 108 may be a duration of time utilized by each USB subunit to be initiated by the sequence controller 102. The hardware-timer 116 may further be configured to compare the duration of initialization of each USB subunit with a predefined threshold value. In some aspects of the present disclosure, when the duration of initialization of one or more USB subunits of the plurality of USB subunits 108 is greater than the predefined threshold value, the hardware-timer 116 may be configured to generate an error signal for each USB subunit of the one or more USB subunits. In some other aspects of the present disclosure, when the duration of initialization of two or more USB subunits of the plurality of USB subunits 108 is less than or equal to the predefined threshold value, the hardware-timer 116 may generate an acknowledgement signal for the two or more USB subunits. The hardware-timer 116 may further be configured to transmit the acknowledgement signal to the initialization engine 114. Preferably, the hardware-timer 116 may be a watchdog timer that may be implemented using a digital design hardware (such as Field Programmable Gate Arrays (FPGAs), Application Specific Integrated Circuits (ASICs), a combination of FPGAs and ASICs, and the like. Aspects of the present disclosure are intended to include or otherwise cover any type of the hardware-timer 116 including known, related art, and/or later developed digital countdown timers implemented using hardware circuitry, without deviating from the scope of the present disclosure.

In operation, the system 100 by way of the one or more support units 106 may be configured to generate the set of status signals based on the status of operation of each support unit of the one or more support units 106. The system 100, by way of the master controller 104 may be configured to generate the plurality of mode signals for the plurality of USB subunits 108 based on the status of dependence of each USB subunit of the plurality of USB subunits 108 on the one or more support units 106. Upon generation of the set of status signals and the plurality of mode signals, the system 100, by way of the sequence controller 102 may be configured to receive the one or more status signals and the plurality of mode signals from the one or more support subunits 106 and the master controller 104, respectively, and compare the plurality of mode signals with the set of predefined signals. The system 100, by way of the sequence controller 102 may further be configured to generate the set of initialization signals for the plurality of USB subunits 108 based on the one or more status signals and the comparison of the plurality of mode signals with the set of predefined signals. Upon initialization of the plurality of USB subunits 108, the system 100, by way of the sequence controller 102, may be configured to determine the duration of initialization for each USB subunit of the plurality of USB subunits 108. The system 100, by way of the sequence controller 102, may further be configured to compare the duration of initialization of each USB subunit with the predefined threshold value. In some aspects of the present disclosure, when the duration of initialization of the one or more USB subunits of the plurality of USB subunits 108 is greater than the predefined threshold value, the system 100, by way of the sequence controller 102, may be configured to generate the error signal for each USB subunit of the one or more USB subunits. In some other aspects of the present disclosure. In some other aspects of the present disclosure, when the duration of initialization of two or more USB subunits of the plurality of USB subunits 108 is less than or equal to the predefined threshold value, the system 100, by way of the sequence controller 102, may generate the acknowledgement signal for transfer of data between the two or more USB subunits of the plurality of USB subunits 108.

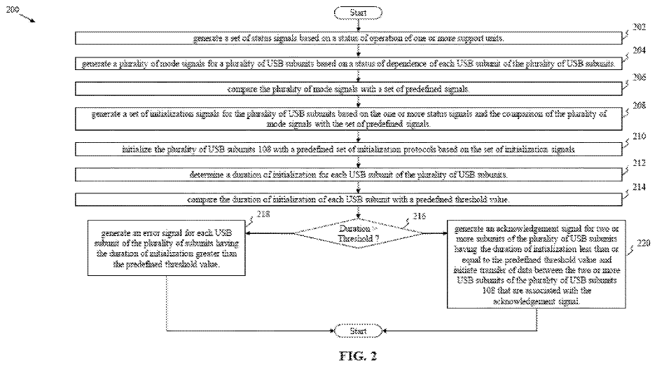

FIG. 2 illustrates a flow chart of a method 200 for the hardware-based data transfer, in accordance with an exemplary aspect of the present disclosure.

At step 202, the system 100 may generate the set of status signals based on a status of operation of each support unit of the one or more support units 106.

In some aspects of the present disclosure, to generate the set of status signals, the system 100 may determine the set of parametric values for the set of predefined performance parameters associated with each support unit. The system 100 may further compare the set of parametric values for each support unit with the predefined set of value. Furthermore, the system 100 may determine the status of operation of each support unit based on the comparison of the set of parametric values for each support unit with the predefined set of value.

In some aspects of the present disclosure, the set of support signals generated by the one or more support units 106 may include the support signal associated with each support unit of the one or more support units 106 such that each support signal may represent the readiness of the associated support unit of the one or more support units 106 to provide support to the sequence controller 102 for initialization of the plurality of USB subunits 108 as and when required by the sequence controller 102.

At step 204, the system 100 may generate the plurality of mode signals for the plurality of USB subunits 108 based on the status of dependence of each USB subunit of the plurality of USB subunits 108 on the one or more support units 106.

In some aspects of the present disclosure, to generate the plurality of mode signals, the system 100 may determine the plurality of specifications of the plurality of USB subunits 108 (i.e., specifications of each USB subunit of the plurality of USB subunits 108 are cumulatively referred to as the plurality of specifications). The system 100 may further compare the plurality of specifications with the set of predefined specifications. Furthermore, the system 100 may determine the status of the dependence of each USB subunit of the plurality of USB subunits on the one or more support units 106 based on the comparison of the plurality of specifications with the set of predefined specifications. In some aspects of the present disclosure, the system 100 may generate a mode signal for a USB subunit of the plurality of USB subunits based on the status of dependence of the USB subunit of the plurality of USB subunits 108.

At step 206, the system 100 may compare the plurality of mode signals with the set of predefined signals.

At step 208, the system 100 may generate the set of initialization signals for the plurality of USB subunits 108 based on the one or more status signals and the comparison of the plurality of mode signals with the set of predefined signals.

At step 210, based on the set of initialization signals, the system 100 may initialize the plurality of USB subunits 108 by way of the predefined set of initialization protocols.

In some aspects of the present disclosure, the system 100 by way of the predefined set of initialization protocols may enable at least one of a parallel initiation of the plurality of USB subunits 108, a sequential initiation of the plurality of USB subunits 108, or a combination thereof.

At step 212, the system 100 may determine the duration of initialization for each USB subunit of the plurality of USB subunits 108.

At step 214, the system 100 may compare the duration of initialization of each USB subunit with the predefined threshold value.

In some aspects of the present disclosure, the system 100 may facilitate the user to provide the predefined threshold value.

At step 216, Based on the comparison of the duration of initialization with the predefined threshold value, when the duration of initialization of one or more USB subunits of the plurality of USB subunits 108 is greater than the predefined threshold value, the system 100 may proceed to step 218, else when the duration of initialization of two or more USB subunits of the plurality of USB subunits 108 is less than or equal to the predefined threshold value, the system 100 may proceed to step 220.

At step 218, when the duration of initialization of one or more USB subunits of the plurality of USB subunits 108 is greater than the predefined threshold value, the system 100 may generate the error signal for each USB subunit of the one or more USB subunits of the plurality of subunits having the duration of initialization greater than the predefined threshold value.

At step 220, when the duration of initialization of the two or more USB subunits of the plurality of USB subunits 108 is less than or equal to the predefined threshold value, the system 100 may generate an acknowledgement signal and initiate transfer of data between the two or more USB subunits of the plurality of USB subunits 108 that are associated with the acknowledgement signal.

As mentioned, there is a need for a system and a method capable of providing secure data transfer between data storage devices. The present aspects, therefore: provides the system 100 and the method 200 that provides secure data transfer in a sequential manner or a parallel manner between storage devices to overcome the aforementioned problems. Specifically, the various components of the system 100 (i.e., the sequence controller 102 the master controller 104, the one or more support units 106, and the plurality of USB subunits 108) are implemented only on hardware and does not use any software for data transfer between the plurality of USB subunits 108. As the various components of the system 100 are implemented at least one of a Field Programmable Gate Array (FPGA), Application Specific Integrated Circuits (ASICs), or a combination thereof (i.e., hardware implemented digital circuitry), the system 100 is nearly impossible to be hacked and thus provides an extensive data security of data transfer. The hardware implementation of the protocols that provide the overall functionality of the system 100 (as discussed hereinabove through steps 202 to 220 of the method 200) further enhances the efficiency and reduces latency of data transfer.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This method of disclosure is not to be interpreted as reflecting an intention the present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

As one skilled in the art will appreciate, the system 100 includes a number of functional blocks in the form of a number of units and/or engines. The functionality of each unit and/or engine goes beyond merely finding one or more computer algorithms to carry out one or more procedures and/or methods in the form of a predefined sequential manner, rather each engine explores adding up and/or obtaining one or more objectives contributing to an overall functionality of the system 100. Each unit and/or engine may not be limited to an algorithmic and/or coded form, rather may be implemented by way of one or more hardware elements operating together to achieve one or more objectives contributing to the overall functionality of the system 100. Further, as it will be readily apparent to those skilled in the art, all the steps, methods and/or procedures of the system 100 are generic and procedural in nature and are not specific and sequential.

Certain terms are used throughout the following description and claims to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims.

We claim:

1. A system comprising:
a plurality of Universal Serial Bus (USB) subunits;
one or more support units configured to generate a set of status signals based on a status of operation of each support unit of the one or more support units;
a master controller configured to generate a plurality of mode signals for the plurality of USB subunits based on a status of dependence of each USB subunit of the plurality of USB subunits on the one or more support units; and
a sequence controller that is coupled to the master controller and the one or more support units, and configured to (i) generate a set of initialization signals for the plurality of USB subunits based on (a) the one or more status signals and (b) a comparison of the plurality of mode signals with a set of predefined signals, (ii) initialize the plurality of USB subunits with a predefined set of initialization protocols based on the set of initialization signals, and (iii) control a transfer of data between the plurality of USB subunits,
wherein the master controller, the one or more support units, and the sequence controller are implemented on at least one of a Field Programmable Gate Array (FPGA), an Application-Specific Integrated Circuit (ASIC), or a combination thereof.

2. The system as claimed in claim 1, wherein prior to the generation of the plurality of mode signals, the master controller is configured to (i) determine a plurality of specifications of the plurality of USB subunits (ii) compare the plurality of specifications with a set of predefined specifications, and (iii) determine the status of the dependence of each USB subunit of the plurality of USB subunits on the one or more support units based on the comparison.

3. The system as claimed in claim 1, wherein prior to the generation of the one or more status signals, each support unit of the one or more support units are configured to (i) determine a set of parametric values for a set of predefined performance parameters associated with each support unit, (ii) compare the set of parametric values for each support unit with a predefined set of value, and (iii) determine the status of operation of each support unit based on the comparison.

4. The system as claimed in claim 1, wherein the predefined set of initialization protocols comprising at least one of a parallel initiation of the plurality of USB subunits, a sequential initiation of the plurality of USB subunits, or a combination thereof.

5. The system as claimed in claim 1, wherein upon initialization of the plurality of USB subunits, the sequence controller is configured to (i) determine a duration of initialization for each USB subunit of the plurality of USB subunits, (ii) compare the duration of initialization of each USB subunit with an predefined threshold value, (iii) generate an error signal for one or more USB subunits of the plurality of USB subunits when the duration of initialization of the one or more USB subunits is greater than the predefined threshold value, and (iv) generate a data transfer signal to enable the transfer of data between two or more USB subunits of the plurality of USB subunits, when the duration of initialization of the two or more USB subunits of the plurality of USB subunits is less than or equal to the predefined threshold value.

6. A method comprising:
generating, by way of one or more support units, a set of status signals based on a status of operation of each support unit of the one or more support units;
generating, by way of a master controller, a plurality of mode signals for a plurality of USB subunits based on a status of dependence of each USB subunit of the plurality of USB subunits on the one or more support units;
generating, by way of a sequence controller, a set of initialization signals for the plurality of USB subunits based on (a) the one or more status signals and (b) a comparison of the plurality of mode signals with a set of predefined signals;
initializing, by way of the sequence controller, the plurality of USB subunits with a predefined set of initialization protocols based on the set of initialization signals; and
controlling, by way of the sequence controller, a transfer of data between the plurality of USB subunits,
wherein the master controller, the one or more support units, and the sequence controller are implemented on at least one of a Field Programmable Gate Array (FPGA), an Application-Specific Integrated Circuit (ASIC), or a combination thereof.

7. The method as claimed in claim 6, wherein prior to generating the plurality of mode signals, the method comprising (i) determining, by way of the master controller, a plurality of specifications of the plurality of USB subunits (ii) comparing, by way of the master controller, the plurality of specifications with a set of predefined specifications, and (iii) determining, by way of the master controller, the status of the dependence of each USB subunit of the plurality of USB subunits on the one or more support units based on the comparison.

8. The method as claimed in claim 6, wherein prior to generating the one or more status signals, the method comprising (i) determining, by way of each support unit of the one or more support units, a set of parametric values for a set of predefined performance parameters associated with each support unit, (ii) comparing, by way of each support unit, the set of parametric values for each support unit with a predefined set of value, and (iii) determining, by way of each support unit, the status of operation of each support unit based on the comparison.

9. The method as claimed in claim 6, wherein predefined set of initialization protocols comprising at least one of a parallel initiation of the plurality of USB subunits, a sequential initiation of the plurality of USB subunits, or a combination thereof.

10. The method as claimed in claim 6, wherein upon initialization of the plurality of USB subunits, the method comprising (i) determining, by way of the sequence controller, a duration of initialization for each USB subunit of the plurality of USB subunits, (ii) comparing, by way of the sequence controller, the duration of initialization of each USB subunit with an predefined threshold value, (iii) generating, by way of the sequence controller, an error signal for one or more USB subunits of the plurality of USB subunits when the duration of initialization of the one or more USB subunits is greater than the predefined threshold value, and (iv) generating, by way of the sequence controller, a data transfer signal to enable the transfer of data between two or more USB subunits of the plurality of USB subunits, when the duration of initialization of the two or more USB subunits of the plurality of USB subunits is less than or equal to the predefined threshold value.
